(19) United States
(12) Patent Application Publication
(10) Pub. No.: US 2005/0010914 A1
(43) Pub. Date: Jan. 13, 2005

(54) Method for upgrading firmware

(76) Inventors: Wan-Pei Liang, Taipei City (TW); Jing-Shun Lin, Wujie Township (TW); Chao-Lien Tsai, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/886,091

(22) Filed: Jul. 7, 2004

(30) Foreign Application Priority Data
Jul. 10, 2003 (TW) 92118817

(51) Int. Cl. G06F 9/44

(52) U.S. Cl. 717/168

(57) ABSTRACT

A method for upgrading firmware by a volume label applicable to a computer system and an apparatus connected thereto, the apparatus comprises at least a memory. First, a button is pressed to change the volume label to an update state. Then, the computer system sends a new upgrade file to the memory according to the update state. Then, the volume label is changed from the update state to a burn state. Thereafter, the apparatus sends the new upgrade file from the memory to a synchronous dynamic RAM. Then, the apparatus reads an upgrade software program from an RAM. Finally, the upgrade software program writes the new upgrade file to a flash memory.

### BACKGROUND OF THE INVENTION

1. Field of the Invention

The present invention relates to a method for upgrading firmware, and in particular to a method for upgrading firmware with a volume label.

2. Description of the Related Art

It is occasionally necessary to upgrade firmware in an electronic product. This need might arise when enhanced firmware functionality is required or whenever the normal functionality of the electronic product requires upgrade or modification. Conventional techniques for upgrading firmware typically require an instrument technician or other qualified individual with specialized knowledge of the firmware. There is, however, no guarantee that the electronic product will not be damaged during the process.

FIG. 1 is a schematic diagram showing a conventional firmware upgrade for a digital camera. User 30 directs a computer system 20 to download a new firmware from a network server 10, and installs the new firmware on a digital camera 40. After installing the new firmware on the digital camera 40, the computer system 20 saves the new firmware in a memory card. Finally, the digital camera 40 is restarted and user 30 continues to execute the firmware update process until complete.

Updating firmware is problematic. This process is typically performed manually by a user. The process may involve executing an upgrade program, then resetting the digital camera. Moreover, manual firmware updating is inconvenient, and may lead to errors caused by incompatible versions of firmware.

### SUMMARY OF THE INVENTION

Accordingly, the invention provides a method for updating firmware with a button, offering a firmware update process with increased ease of operation, and reduced errors due to the firmware upgrade process.

The apparatus for upgrading firmware utilizing a volume label according to the present invention comprises a connection port, a management module, a memory, a synchronous dynamic RAM and a flash memory.

The connection port receives a new upgrade file from a computer system. The management module changes the volume label to an upgrade state. The memory is connected to the management module, and saves the new upgrade file. The synchronous dynamic RAM is connected to the memory, and receives the new upgrade file from the memory. The flash memory is connected to the synchronous dynamic RAM, and saves an existing firmware.

The method for upgrading firmware utilizing a volume label applies a computer system and an apparatus connected thereto, the apparatus comprises at least a memory. First, a button is pressed to change the volume label to an update state. The computer system then sends a new upgrade file to the memory according to the update state. The volume label is then changed from the update state to a burn state. Thereafter, the apparatus sends the new upgrade file from the memory to a synchronous dynamic RAM. The apparatus then reads an upgrade software program from an RAM. Finally, the upgrade software program writes the new upgrade file to a flash memory in the apparatus.

The invention provides another method for upgrading firmware utilizing a volume label applicable to an apparatus comprising at least a memory. First, a button is pressed to change the volume label to an update state. A computer system then sends a new upgrade file to the memory according to the update state. The volume label is then changed from the update state to a burn state. Thereafter, a synchronous dynamic RAM receives the new upgrade file from the memory. The apparatus then reads an upgrade software program from an RAM. Finally, the upgrade software program writes the new upgrade file to a flash memory in the apparatus.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram showing a conventional firmware upgrade for a digital camera;

FIG. 2 is a schematic diagram showing the architecture of a digital camera and a computer system according to the present invention; and

FIGS. 3A and 3B is a flowchart showing the method utilizing a volume label for upgrading firmware according to the present invention.

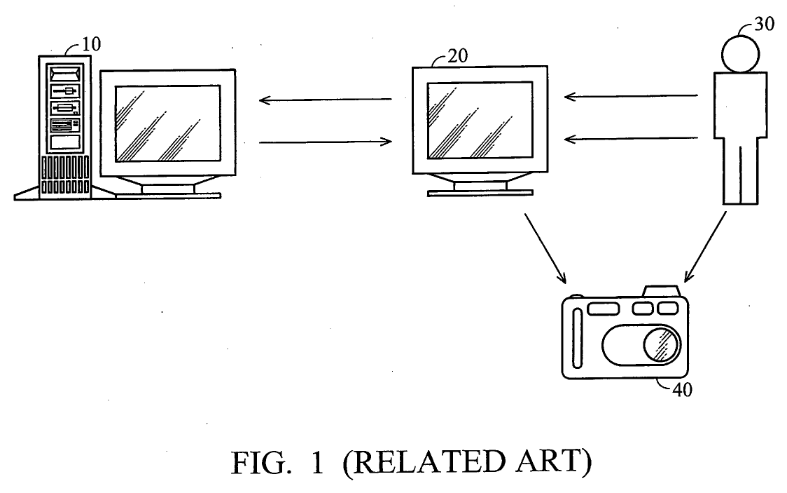

### DETAILED DESCRIPTION OF THE INVENTION

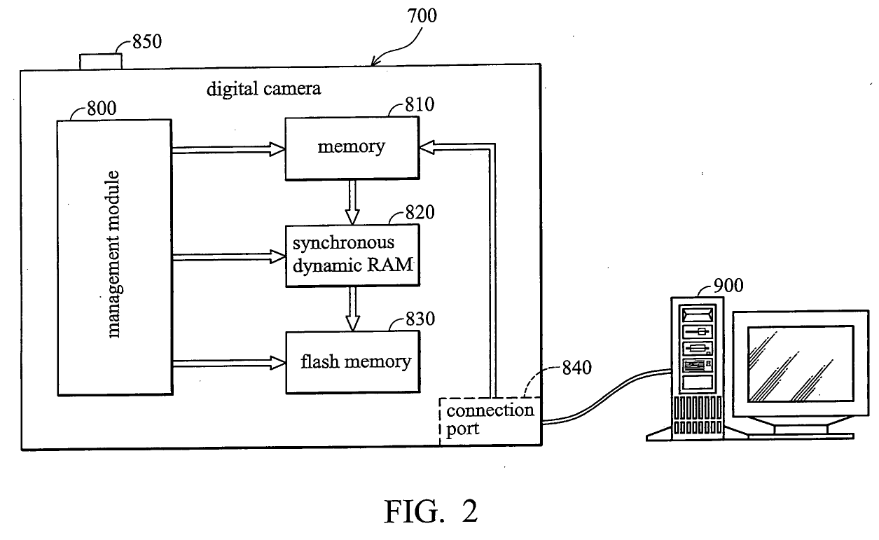

FIG. 2 is a schematic diagram showing the architecture of a digital camera and a computer system according to the present invention.

The digital camera 700 comprises a management module 800, a memory 810, a synchronous dynamic RAM 820, a flash memory 830, a connection port 840, and a button 850.

The button 850 is pressed to activate the management module 800 to change a volume label to an update state. The digital camera 700 via the connection port 840 receives a new upgrade file from the computer system 900 and stores the new upgrade file in the memory 810, which can be a multimedia card (MMC), a secure digital (SD) card, a smart media card (SMC), a compact flash (CF) card, a microdrive card, a memory stick (MS) or an integrated memory.

The management module 800 sends the new upgrade file from the memory 810 to the synchronous dynamic RAM 820 and deletes the new upgrade file in the memory 810 when the volume label is changed from the update state to a burn state.

The management module 800 reads a software program from an RAM and writes the new upgrade file to the flash memory 830 via the software program.

In addition, the upgrade software program can be stored in the flash memory 830, and when executed writes the new upgrade file to the flash memory 830.

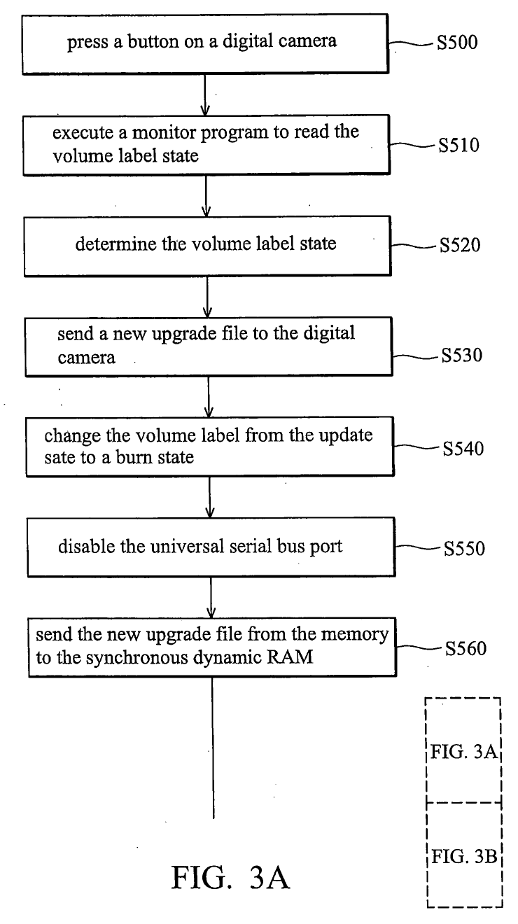

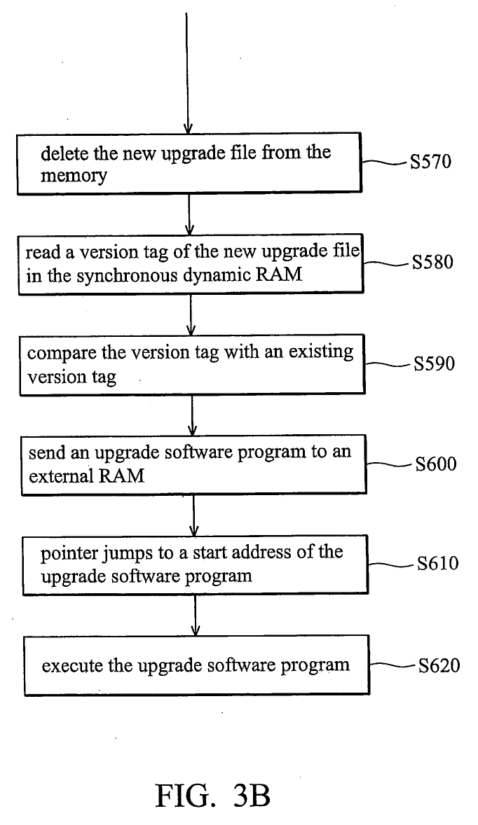

FIG. 3 is a flowchart showing the method utilizing a volume label for upgrading firmware according to the present invention.

First, in step S500, a button is pressed on a digital camera to switch a volume label to an update state. The digital camera is connected to a computer system with a universal serial bus port or IEEE 1394 port.

Then, in step S510, the computer system executes a monitor program to read the volume label state. In step S520, the monitor program determines the volume label state. The monitor program reads the volume label state from the memory and determines if the volume label state is in an update state.

In step S530, the computer system sends a new upgrade file to the digital camera according to the volume label state in the update state. The digital camera saves the new upgrade file in a memory.

In step S540, after the digital camera has saved the new upgrade file in the memory, the computer system changes the volume label from the update sate to a burn state. The volume label in update state indicates data transfer between the computer and the digital camera. The volume label in burn state indicates continuation of the firmware update process, and prevents interruption of data transfer to the digital camera.

In step S550, the digital camera disables the universal serial bus port according to the volume label in the burn state to prevent firmware failure of the firmware update process. Thus the computer system stops sending data to the digital camera when the volume label is in the burn sate to prevent errors. The digital camera determines that the download is complete when the volume label is in the burn state.

After the digital camera downloads the new upgrade file completely, in step S560, the digital camera sends the new upgrade file from the memory to the synchronous dynamic RAM.

After the synchronous dynamic RAM successfully receives the new upgrade file, in step S570, the digital camera deletes the new upgrade file from the memory to increase the memory capacity. Then, in step S580, the digital camera reads a version tag of the new upgrade file in the synchronous dynamic RAM. The new upgrade file comprises several bytes storing version data for identification of the new upgrade file version.

In step S590, the digital camera compares the version tag with an existing version tag stored in a flash memory. If the existing firmware is the latest version, the digital camera automatically terminates the update process. If not, in step S600, the digital camera sends an upgrade software program to an RAM.

In step S610, a pointer in the digital camera jumps to a start address of the upgrade software program to execute the upgrade software program. Finally, in step S620, the digital camera executes the upgrade software program to write the new upgrade file to a flash memory thus completing the firmware upgrade.

The invention has been described using digital camera as an example, the invention, however, is not limited to this. The method for utilizing a volume label for upgrading firmware is also applicable to cellular phones, personal digital assistants or computer systems via the bluetooth protocol, infrared ray communications or the global system for mobile communications.

The present invention provides a method for utilizing a volume label for upgrading firmware, utilizing the volume label state to receive the new upgrade file and executing the update process. The digital camera utilizes a button to complete the firmware upgrade preventing failure due to incorrect operation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An apparatus for upgrading firmware, comprising:
a connection port receiving a new upgrade file;
a first memory storing the received new upgrade file;
a second memory storing the new upgrade file stored in the first memory;
a third memory storing the upgrade file stored in the second memory;
a management module, connecting to the connection port, the first, second, and third memory, changing a volume label corresponding to the first memory to an upgrade state, transferring the received new upgrade file from the first memory to the second memory, and loading the new upgrade file from the second memory into the third memory.

2. The apparatus as claimed in claim 1, wherein the apparatus is a digital camera.

3. The apparatus as claimed in claim 1, wherein the management module disables the connection port when the volume label has been changed from an upgrade state to a burn state.

4. The apparatus as claimed in claim 1, wherein the management module deletes the new upgrade file in the first memory after the new upgrade file has been sent to the second memory.

5. The apparatus as claimed in claim 1, wherein the management module reads the upgrade software program from an RAM.

6. The apparatus as claimed in claim 1, wherein the management module compares a version tag in the new upgrade file with an existing version tag in the third memory to determine if the existing version tag is a latest firmware version.

7. The apparatus as claimed in claim 1, wherein the first memory is a memory stick.

8. The apparatus as claimed in claim 1, wherein the second memory is a random access memory.

9. The apparatus as claimed in claim 1, wherein the third memory is a flash memory.

10. A method for upgrading firmware utilizing a volume label applicable to a computer system and an apparatus connected thereto, the apparatus comprising at least a memory, comprising the steps of:
changing the volume label in the memory to an update state by pressing a button;
sending a new upgrade file from the computer system to the memory according to the update state;
changing the volume label form the update state to a burn state by the computer system;
sending the new upgrade file from the memory to a synchronous dynamic RAM by the apparatus;
reading an upgrade software program by the apparatus; and
writing the new upgrade file to a flash memory in the apparatus by the upgrade software program to complete the firmware upgrade.

11. The method as claimed in claim 10, wherein the apparatus is a digital camera.

12. The method as claimed in claim 10, wherein the apparatus disables a connection port between the apparatus and the computer system when the volume label is changed from the upgrade state to a burn state.

13. The method as claimed in claim 10, wherein the apparatus deletes the new upgrade file in the memory after the apparatus sends the new upgrade file from the memory to the synchronous dynamic RAM.

14. The method as claimed in claim 10, wherein the apparatus reads the upgrade software program from an RAM.

15. The method as claimed in claim 10, wherein the apparatus compares a version tag in the new upgrade file with an existing version tag in the flash memory to determine if the existing version tag is a latest firmware version.

16. The method as claimed in claim 10, wherein a pointer directs the upgrade software program to write the new upgrade file from the synchronous dynamic RAM to the flash memory by the upgrade software program.

17. A method for upgrading firmware utilizing a volume label in an apparatus comprising at least a memory, comprising steps of:
changing the volume label in the memory to an update state by pressing a button;
sending a new upgrade file from a computer system to the memory according to the update state by an external computer system;
changing the volume label form the update state to a burn state;
sending the new upgrade file from the memory to a synchronous dynamic RAM;
reading an upgrade software program by the apparatus; and
writing the new upgrade file to a flash memory by the upgrade software program to complete the firmware upgrade.

18. The method as claimed in claim 17, wherein the apparatus is a digital camera.

19. The method as claimed in claim 17, wherein the apparatus disables a connection port between the apparatus and the computer system when the volume label is changed from the upgrade state to a burn state.

20. The method as claimed in claim 17, wherein the apparatus deletes the new upgrade file in the memory after the apparatus sends the new upgrade file from the memory to the synchronous dynamic RAM.

21. The method as claimed in claim 17, wherein the apparatus reads the upgrade software program from an RAM.

22. The method as claimed in claim 17, wherein the apparatus compares a version tag in the new upgrade file with an existing version tag in the flash memory to determine if the existing version tag is a latest firmware version.

23. The method as claimed in claim 17, wherein a pointer directs to the upgrade software program to write the new upgrade file from the synchronous dynamic RAM to the flash memory by the upgrade software program.
